(19) United States
(12) Patent Application Publication
(10) Pub. No.: US 2022/0050702 A1
(43) Pub. Date: Feb. 17, 2022

(54) VIRTUALIZATION FOR AUDIO CAPTURE

(71) Applicant: ADVANCED MICRO DEVICES, INC., Santa Clara, CA (US)

(72) Inventor: Virendra Pratap ARYA, Hyderabad (IN)

(21) Appl. No.: 17/130,657

(22) Filed: Dec. 22, 2020

Related U.S. Application Data
(60) Provisional application No. 63/066,607, filed on Aug. 17, 2020.

(51) Int. Cl. G06F 9/455; G06F 9/4401; G06F 9/54; G06F 3/16

(52) U.S. Cl. CPC G06F 9/45558; G06F 9/4411; G06F 2009/45595; G06F 3/162; G06F 2009/45579; G06F 9/544

(57) ABSTRACT

Captured audio data is provided by a streaming interface to a multimedia application (e.g., a game, voice chat app or a recording app) via a virtual audio driver in accordance with some embodiments. The virtual audio driver is a software module that provides an interface between virtual audio hardware of a virtualized computing environment (e.g., a virtual machine or a remote machine) and the multimedia application, allowing the multimedia application to interact with the audio hardware using application program interfaces (APIs) and other software resources.

### BACKGROUND

To support both improved processing efficiency and simplified programming models, some processing systems implement a virtualized computing environment. In such an environment, a processing system provides, via software, hardware, or a combination thereof, one or more layers of abstraction between the hardware resources of the processing system and specified sets of software referred to as virtual machines. For example, in some cases the processing system implements a hypervisor that provides an interface between one or more virtual machines executing at the processing system and the underlying system hardware. The hypervisor provides message translation and resource management operations that allow the virtual machine to interact with the hardware resources of the processing system, even when the virtual machine has been developed to be executed by or interact with different resources of the processing system. Thus, for example, the hypervisor can be implemented at a server, allowing the server to execute virtual machines including operating systems, applications, and other programs that has been designed to be executed at a personal computer, game console, or other hardware, without requiring redesign of the programs. However, given the relative complexity of implementing multimedia operations at a processing system, supporting multimedia content in a virtualized computing environment present additional challenges.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a computer network that supports audio data capture for a virtualized computing environment in accordance with some embodiments.

FIG. 2 is a block diagram of a virtual machine of FIG. 1 implementing audio data capture from a client device via a virtual audio driver in accordance with some embodiments.

FIG. 3 is a diagram illustrating a streaming interface of the virtual machine of FIG. 1 that supports audio data capture via a virtual audio driver in accordance with some embodiments.

FIG. 4 is a flow diagram of a method of receiving captured audio data from a client device at a virtualized computing environment in accordance with some embodiments.

FIG. 5 is a block diagram of the server of FIG. 1 in accordance with some embodiments.

### DETAILED DESCRIPTION

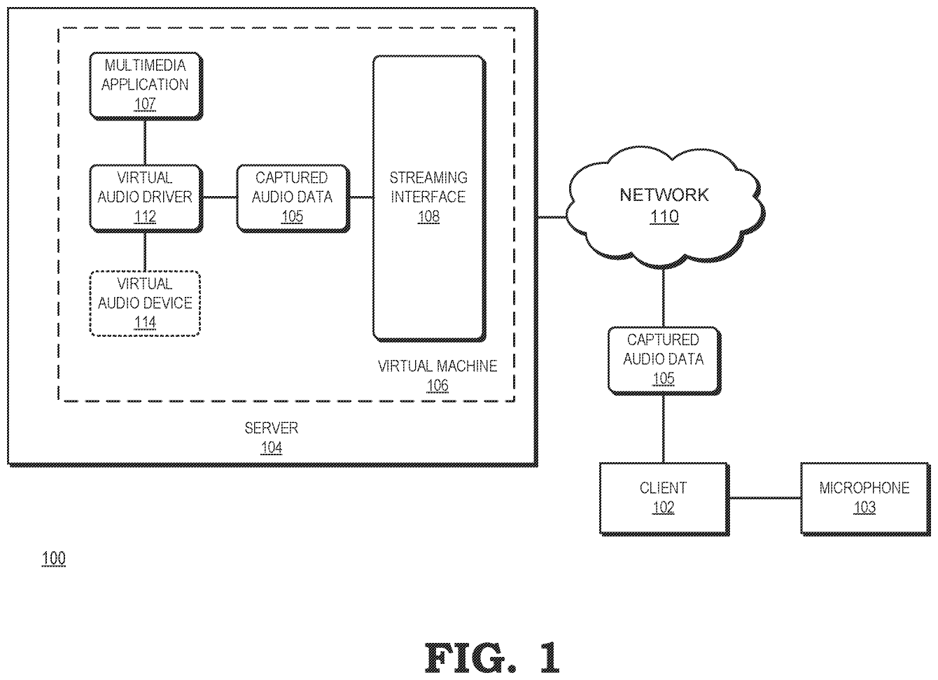

FIGS. 1-5 illustrate techniques for providing captured audio data to a multimedia application (e.g., a game, voice chat app or a recording app) via a virtual audio driver in accordance with some embodiments. The virtual audio driver is a software module that provides an interface between virtual audio hardware of, for example, a virtualized computing environment (e.g., a virtual machine or a remote machine) and the multimedia application, allowing the multimedia application to interact with the audio hardware using application program interfaces (APIs) and other software resources. By providing the captured audio data via the virtual audio driver, the virtual machine supports efficient use of hardware resources without requiring redesign or reconfiguration of the virtual machine software, thereby supporting increased flexibility of the virtualized computing environment.

To illustrate via an example, in some embodiments a server of a network computing system implements a virtualized computing environment by executing one or more virtual machines. A program (e.g., a game application) of a virtual machine generates audio data, and the virtual machine employs a streaming interface to stream the generated audio data to a client device over a network. The program provides the audio data to the streaming interface via a virtual audio driver according to a specified driver model associated with an operating system of the virtual machine. The virtual audio driver thus appears to the program as a standard audio driver representing a local audio device. However, the virtual audio driver provides the generated audio data to the streaming interface for provision to the client device.

Furthermore, the client device captures audio data via an input device (e.g., a microphone) and provides the captured audio data to the server via the network. The streaming interface receives the captured audio data processes the received data and provides the processed captured audio data to the virtual audio driver, which in turn stores the captured audio data at a buffer of an operating system of the virtual machine. The captured audio data is thus provided to the multimedia application via the virtual audio driver, so that the data appears to the operating system as having been captured by a local audio device. This allows the operating system and program to process the captured audio data according to standard protocols, without requiring redesign or reconfiguration of either the operating system or program.

In some embodiments, the streaming interface captures the rendering data generated by the executing program, via loopback capture. The streaming interface provides this data to client devices via the network. The streaming interface thereby supports efficient provisioning of captured audio data in a networked computing system. For example, in some embodiments the captured audio data is voice data captured as part of a network game application executing at a client device. The streaming interface provides the captured voice data to other client devices via the virtual audio driver, allowing players of the game to conduct a voice chat over the network while playing the game.

Turning to the Figures, FIG. 1 illustrates a computer network 100 that supports audio data capture for a virtualized computing environment in accordance with some embodiments. The computer network 100 includes a client device (also referred to as a client) 102 and a server 104 connected via a network 110. The client 102 is a device generally including a processor (not shown) configured to execute sets of instructions (e.g., programs) to perform specified operations. Accordingly, in different embodiments the client 102 is a desktop computer, laptop computer, server, game console, smartphone, tablet, and the like. In some embodiments, the client 102 includes additional components not illustrated at FIG. 1, including one or more processing units, memory modules, memory controllers, and input/output devices to support execution of operations.

The network 110 represents network infrastructure for a computer network, such as one or more access points, routers, servers, and the like that together support communication between the server 104 and the client 102. Accordingly, in some embodiments the network 110 is a packet-switched network, such as the Internet, that communicates packets between network nodes based on address information included with each packet. The packets include data payloads that include information of different types, such as program data, video data, audio data and the like. Further, in some embodiments the network 110 includes multiple sub-networks, such as one or more local area networks (LANs), one or more wide area networks (WANs), and the like, or any combination thereof.

The server 104 is a computer device that is configured to execute a virtualized computing environment by executing one or more virtual machines (e.g., virtual machine 106) and providing interfaces (e.g., streaming interface 108) between applications (e.g., multimedia application 107) executed by the virtual machines and the underlying hardware resources of the server 104. The interfaces are associated with corresponding drivers (e.g., virtual audio driver 112), and the drivers and interfaces are configured so that the virtual machines are able to communicate with each driver and interface according using standard APIs and other operating system resources, and the drivers and interfaces translate the communications, and manage the corresponding hardware resources of the server 104, to allow the virtual machines to use the hardware resources.

For example, in some embodiments the virtual machine 106 executes at least one multimedia program 107 and an operating system (e.g., the Windows® operating system). The multimedia program 107 interacts with hardware resources by issuing messages to one or more APIs of the operating system, which processes the messages based a specified protocol. Based on the processed messages, the operating system issues commands via one or more device drivers, wherein each command requests execution of a corresponding set of operations at one or more hardware resources. The interfaces of the server 104 translate the commands to a corresponding set of server-hardware commands, thereby implementing the set of operations at the hardware resources of the server 104. The interfaces also translate any messages generated by the hardware resources based on the server-hardware commands to a specified format expected by the operating system and provide the translated message to the operating system for processing. The drivers and interfaces of the server 104 thereby provide a layer of abstraction between the hardware resources and the virtual machine 106, allowing the hardware resources to appear as local resources of a computer dedicated to the execution of the operating system and corresponding programs. In some embodiments, one or more aspects of the drivers and interfaces described herein are implemented by a virtual machine monitor such as a hypervisor.

In some cases, one or more of the virtual machines executing at the server 104 include programs that stream media content, including audio content, to the client 102. Examples of such programs include, in different embodiments, video game programs, chat programs, video streaming programs, and the like. For example, in some embodiments the virtual machine 106 executes a video game program that generates audio data to be streamed to the client 102. To stream the audio data, the virtual machine 106 employs a virtual audio driver 112 and a streaming interface 108, which together provide a layer of abstraction between an operating system executing at the virtual machine 106 and the streaming audio hardware resources of the server 104.

To illustrate, the virtual audio driver 112 is a device driver that represents a virtual audio device 114 to an operating system executing at the virtual machine 106. In some embodiments, the virtual audio driver 112 appears to the operating system as a driver for a hardware device represented by the virtual audio device 114. Thus, the operating system is able to interact with the virtual audio driver 112 according to a specified device driver protocol. However, in some embodiments the virtual audio device 114 is not a physical device, but merely an abstract representation of such a physical audio device. The streaming interface 108 is a software resource of the virtual machine 106 that is configured to send and receive audio data via the network 110. For example, in some embodiments the streaming interface 108 is a software that execute audio services such as audio format conversion, encoding and decoding, and interfacing with network hardware to send and receive encoded audio data via the network 110.

In operation, the multimedia program 107 generates audio data to be streamed to the client 102 and provides the audio data to the operating system. The audio data is formatted to be rendered (i.e., played) at a physical audio device represented by the virtual audio device 114. The operating system employs a set of APIs and audio engines to process the received audio data, including generating a set of commands to render the audio data at the physical device represented by the virtual audio device 114, and provides the commands and audio data to the virtual audio driver 112. Thus, the program and game application process audio data and interact with the virtual audio driver 112 as if the audio data is to be played at a local physical audio device, as represented by the virtual audio device 114.

The virtual audio driver 112 discards the received commands and audio data, as there is no physical audio device to render the audio data. To stream the audio data to the network 110, the streaming interface 108 retrieves the audio data from a loopback buffer of the operating system (e.g., via an audio session API). The streaming interface 108 converts the audio data to a format for rendering at the client device 102, encodes the audio data for network transmission, and employs virtualized hardware resources of the virtual machine 106, such as a network interface, to stream the audio data to the client 102 via the network 110. The client 102 decodes the received audio data and renders the audio data at a local audio device, such as a set of speakers. Thus, the streaming interface 108 and the virtual audio driver 112 together provide a layer of abstraction between the virtual machine 106 and the hardware of the server 104, allowing the virtual machine to stream audio data via the network 110 using commands, data formats, and the like, that are configured for a local physical audio device represented by the virtual audio device 114.

In some embodiments, a program at the client 102 generates captured audio data 105 to be streamed to the multimedia program. For example, in some cases the client executes a client-side program associated with the streaming interface 108, wherein the client-side program captures voice data spoken into a microphone 103 or other audio capture device. The client-side program processes the voice data and provides the processed data to the network 110 as captured audio data 105. However, as explained above, in at least some embodiments the programs and operating system implemented by the virtual machine are configured to interact with local audio devices, and not to receive and process audio data streamed via a network. Accordingly, the streaming interface 108 and the virtual audio driver 112 are configured to provide a layer of abstraction so that audio data received via the network 110 appears to the multimedia program 107 as if the data were captured by a local audio device represented by the virtual audio device 114.

To illustrate, the streaming interface 108 is configured to employ a network interface or other virtualized hardware of the virtual machine 106 to receive the captured audio data 105 from the network 110. The streaming interface 108 decodes the captured audio data 105 and converts the decoded data to a format expected by the operating system executing at the virtual machine 106. The streaming interface provides the decoded and converted captured audio data 105 to the virtual audio driver 112, which in turn provides the data to the operating system, such as by storing the captured audio data 105 at a buffer. In some embodiments, the buffer is configured by the operating system to store data received from a device driver associated with a local audio device. That is, the buffer is configured to store audio data captured with a local audio device, and thus the captured audio data 105 appears to the operating system as if the data were captured by a local audio device represented by the virtual audio device 114. The operating system is therefore able to process the captured audio data 105 according to standard processing protocols of the operating system. Thus, by employing the streaming interface 108 and the virtual audio driver 112, the server 104 is able to provide audio data received via the network 110 to programs of the virtual machine 106, without requiring special configuration or redesign of those programs. The server 104 therefore supports implementation of a wide variety of programs at the virtual machine 106, including game programs, chat programs, streaming programs, and the like.

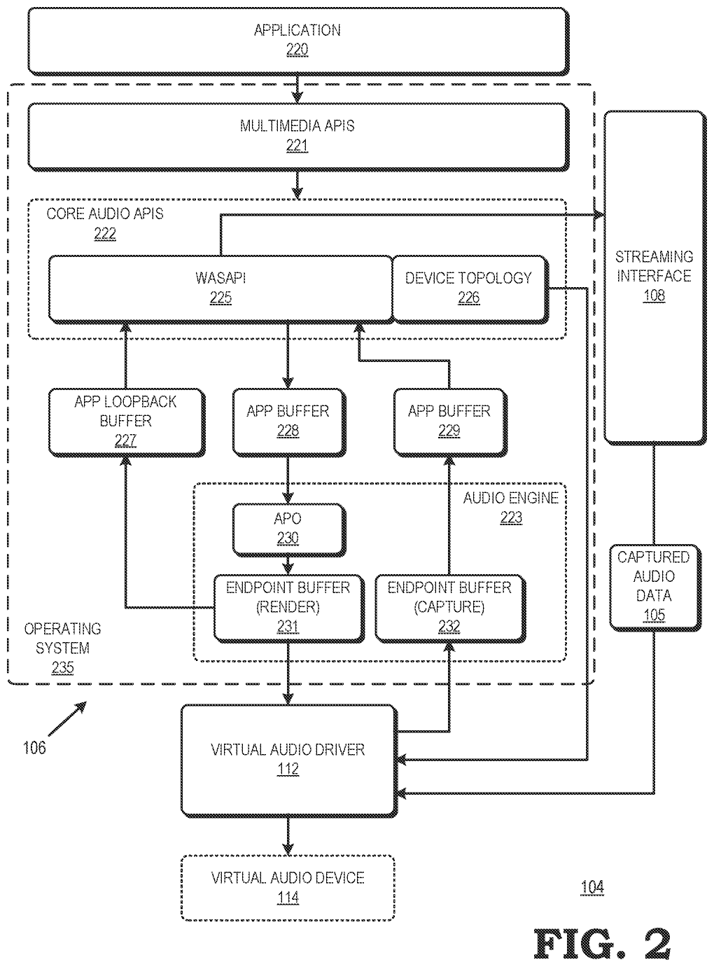

FIG. 2 is a block diagram of the virtual machine 106 implementing audio data capture from the client 102 via the virtual audio driver 112 in accordance with some embodiments. In the illustrated example, the virtual machine 106 executes an application 220 and an operating system 235. The application 220 is any program that is configured to support reception of audio data captured at a local physical audio capture device, such as the multimedia program 107 of FIG. 1. Thus, in different embodiments the application 220 is a video game program, a chat program (e.g., a video chat program), a video streaming program that receives voice commands, and the like. The operating system 235 is any operating system that supports execution of the application 220, and in particular supports processing of audio data for reception or rendering at a local audio device represented by the virtual audio device 114. For purposes of description, it is assumed that the operating system 235 is a Windows® operating system, but it will be appreciated that in other embodiments the operating system 235 is another desktop computer operating system, a game console operating system, a smartphone operating system, and the like.

In the depicted example, the operating system 235 includes APIs, buffers, and engines to support processing of audio data, including multimedia APIs 221, core audio APIs 222, application loopback buffer 227, application buffers 228 and 229, and audio engine 223. The multimedia APIs 221 are a set of APIs that receive commands from the application 220 and generate audio data based on the received commands. For example, in some embodiments the multimedia APIs 221 includes one or more of a Windows® Multimedia API, Media Foundation APIs, and DirectSound APIs.

The core audio APIs 222 includes one or more APIs that allow the application 220 to access audio endpoints, with each audio endpoint associated with an audio device. In at least some embodiments, the core audio APIs 222 interface with the multimedia APIs 221, so that the application 220 interacts directly with the multimedia APIs 221 and based on these interactions the multimedia APIs 221 interact with the core audio APIs 222. In some embodiments, each of the core audio APIs exposes a set of audio controls for the audio device represented by the virtual audio device 114. Thus, in the depicted example, the core audio APIs 222 include a Windows Audio Session API (WASAPI) 225 and a DeviceTopology API 226 that expose audio controls such as volume control, gain control, bass control, mute control, and the like. The core audio APIs 222 also provide access to other audio interfaces and controls, such as session interfaces and controls, render interfaces, and the like. In some embodiments, the core audio APIs 222 include additional APIs not illustrated at FIG. 2, such as an MMDevice API that allows the application 220 to discover audio devices, such as the virtual audio device 114, and create a driver instance of the virtual audio driver 112 for the virtual audio device 114.

The audio engine 223 is a software engine configured to mix and process audio streams. The audio engine 223 loads audio processing objects (APOs) (e.g., APO 230) that are hardware-specific plugins configured to process received audio signals. The audio engine 223 also includes endpoint buffers (e.g., endpoint buffers 231, 232) to store audio data. Each endpoint buffer is associated with an audio endpoint, with each audio endpoint associated with a different audio render or audio capture endpoint of the virtual audio device 114. Thus, in the depicted example, the endpoint buffer 231 is associated with a rendering endpoint of the virtual audio device 114, and thus stores audio data generated by the application 220 to be rendered. The endpoint buffer 232 is associated with a capturing endpoint of the virtual audio device 114, and thus stores captured audio data, as described further herein.

In operation, the application 220 generates audio data to be streamed to, and rendered at, the client 102. To generate the audio data, the application 220 issues a set of commands to the multimedia APIs 221. Based on the set of commands, the multimedia APIs, in conjunction with the core audio APIs 222, generate the audio data and store the generated audio data at application buffer 228. The APO 230 retrieves the audio data from the application buffer 228, processes the audio data according to the configuration of the APO 230, and stores the processed audio data at the endpoint buffer 231.

The endpoint buffer 231 provides the processed audio data to both the virtual audio driver 112 and to a loopback buffer 227 of the operating system 235. The virtual audio driver 112 discards the received audio data, as the driver does not interface with an actual physical audio device. The streaming interface 108 issues commands to the WASAPI 225 to retrieve the processed audio data from the loopback buffer 227, converts the processed audio data to a format expected by the client device 102, and encodes the audio data. The streaming interface 108 then controls a network interface and other virtualized hardware of the virtual machine 106 to provide the encoded audio data to the client 102 via the network 110.

In addition, the streaming interface 108 receives the captured audio data 105, in encoded form, from the network 110. The streaming interface 108 decodes the encoded captured audio data 105, converts the data to a format expected by the application 220, and provides the converted captured audio data 105 to the virtual audio driver 112. In response, the virtual audio driver 112 stores the captured audio data 105 at the endpoint buffer 232 of the audio engine 223. The operating system 235 retrieves the captured audio data from the endpoint buffer 232 and stores the data at the application buffer 229. The core audio APIs 222 and multimedia APIs 221 process the captured audio data 105, as stored at the application buffer 229, based on commands received from the application 220. Thus, because the captured audio data 105 is provided to the virtual audio driver 112, the captured audio data 105 appears to the operating system 235 and the application 220 to be audio data captured at a local audio device, and is therefore processed using the APIs, audio engines, and other modules already implemented by the operating system 235.

In some embodiments, the captured audio data 105 is audio data that is to be streamed to other client devices via the network 110. For example, in some embodiments the captured audio data 105 is voice chat data that is to be streamed to other client devices, thereby allowing users of those devices, and of the client 102, to conduct an audio or video chat.

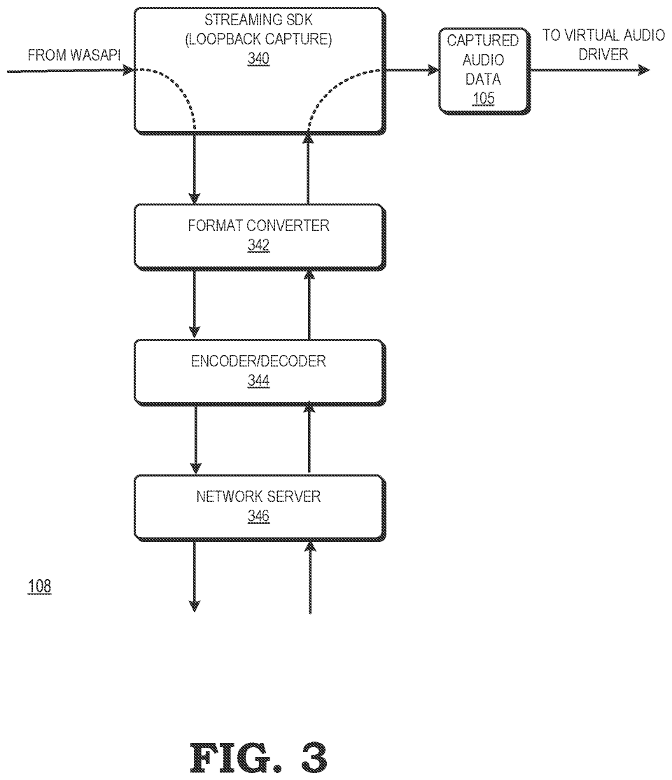

FIG. 3 is a block diagram illustrating stages of the streaming interface 108 in accordance with some embodiments. In the depicted example, the streaming interface includes a streaming software development kit (SDK) stage 340, a format converter stage 342, an encoder/decoder stage 344, and a network server stage 346. The network server stage 346 includes the hardware resources, such as resources of one or more network interfaces of the virtual machine 106, that support transmission and reception of audio data via the network 110.

The encoder/decoder stage 344 includes software configured to perform encoding and decoding of audio data according to one or more specified audio codecs. In some embodiments, the encoder/decoder stage 344 includes separate modules for encoding of audio data to be transmitted by the network 110 and for decoding of audio data, including the captured audio data 105, received from the network 110.

The format converter stage 342 includes software configured to convert received audio from one specified format to a different specified format. For example, in some embodiments the application 220 or the operating system 235 are configured to process audio data that complies with a specified audio format, while the client 102 executes an operating system or applications configured to process data according to a different audio format. The format converter 342 is generally configured to convert audio data between these different formats, allowing the client 102 and the virtual machine 106 to efficiently communicate audio data.

The streaming SDK stage 340 includes one or more APIs, libraries, and associated software that collectively provide an interface to the other stages of the streaming interface 108.

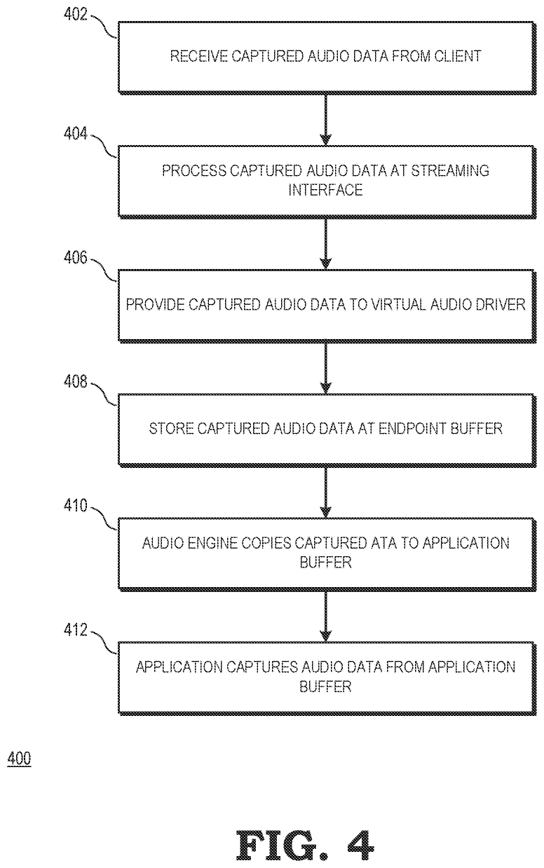

FIG. 4 illustrates a flow diagram of a method 400 of receiving captured audio data from a client device at a virtual machine in accordance with some embodiments. For purposes of description, the method 400 is described with respect to an example implementation at the virtual machine by the server 104. At block 402, the virtual machine 106 receives the captured audio data 105 from the client 102, via the network 110. At block 404, the streaming interface 108 processes the captured audio data 105, including decoding the audio data and converting a format of the audio data to a format expected by the operating system 235 or the application 220.

At block 406, the streaming interface 108 provides the processed captured audio data 105 to the virtual audio driver 112 that is executing at the virtual machine 106. At block 408, the virtual audio driver 112 stores the captured audio data 105 at the endpoint buffer 232. At block 410, the operating system 235 transfers the captured audio data to the application buffer 229, and the application 220 receives application buffer 229 via WASAPI 225 and multimedia APIs 221.

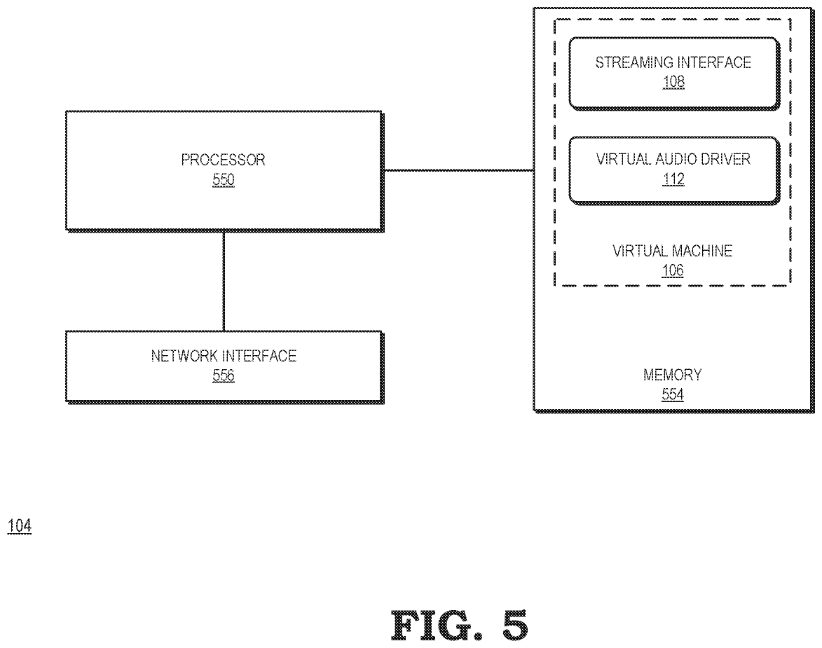

FIG. 5 is a block diagram of the server of FIG. 1 in accordance with some embodiments. In the illustrated example, the server 104 includes a processor 550, a memory 554, and a network interface 556. The network interface 556 is a set of hardware collectively configured to communicate data to and from the network 110. Accordingly, in some embodiments the network interface 556 provides a physical, or PHY, layer to control physical signaling operations to send and receive packets via the network 110. The network interface 556 also provides logic layer services, such as packet formation, traffic control, buffering, and the like.

The processor 550 is a general-purpose or application-specific processor configured to execute sets of instructions (e.g., programs) in order to carry out operations on behalf of the server 104. In some embodiments, the processor 550 represents a collection of multiple processing units, including one or more central processing units (CPUs), one or more graphics processing units (GPUs), one or more digital signal processors (DSPs) and the like, or any combination thereof. In some embodiments, the server 104 includes additional hardware to support execution of instructions, including one or more memory controllers, input/output controllers, additional network interfaces, and the like.

The memory 554 is a non-transitory computer readable medium such as Flash memory, a cache, random access memory (RAM) or other non-volatile memory device or devices, and the like, or any combination thereof. The memory 554 stores sets of executable instructions corresponding to one or more operations of the virtual machine 106, the streaming interface 108, and the virtual audio driver 112. These instructions when executed by the processor 550, manipulate the processor 550 to perform one or more aspects of the techniques described above.

It will be appreciated that although the techniques described herein have been described with respect to implementations associated with a virtualized computing environment, in other embodiments one or more aspects of the described techniques are implemented in non-virtualized computing environments. For example, in some embodiments the virtual audio driver 112 and streaming interface 108 are executed at a server running an operating system directly, in a non-virtualized configuration. In other embodiments, the virtual audio driver 112 and streaming interface 108 are executed in a remote computing environment, such as by executing at a server that is accessed remotely by a client device.

Thus, in some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving captured audio data from a client device via a network; and
providing the captured audio data to a virtual audio driver, the virtual audio driver representative of a local audio device.

2. The method of claim 1, further comprising:
processing the captured audio data at a streaming interface prior to providing the captured audio data to the virtual audio driver.

3. The method of claim 2, wherein processing the captured audio data comprises at least one of decoding the captured audio data and converting a format of the captured audio data.

4. The method of claim 1, further comprising:
storing, by the virtual audio driver, the captured audio data, at an endpoint buffer of an operating system.

5. The method of claim 1, further comprising:
providing, by the virtual audio driver, the captured audio data to an operating system.

6. The method of claim 5, further comprising:
communicating audio data to the network via the virtual audio driver.

7. The method of claim 1, wherein the captured audio data comprises voice chat data.

9. A device comprising:
a network interface to receive captured audio data from a client device via a network; and
a processor to provide the captured audio data to a virtual audio driver, the virtual audio driver representative of a local audio device.

9. The device of claim 8, wherein the processor is to:
process the captured audio data at a streaming interface prior to providing the captured audio data to the virtual audio driver.

10. The device of claim 9, wherein processing the captured audio data comprises at least
one of decoding the captured audio data and converting a format of the captured audio data.

11. The device of claim 8, wherein the virtual audio driver is to:
store the captured audio data at an endpoint buffer of an operating system.

12. The device of claim 8, wherein the virtual audio driver is to:
provide the captured audio data to an operating system.

13. The device of claim 12, wherein the processor is to:
communicating the audio data to the network interface via the virtual audio driver.

14. The device of claim 8, wherein the captured audio data comprises voice chat data.

15. A device comprising:
a network interface; and
at least one processor to:
execute a streaming interface to interface with a virtual machine, the streaming interface to:
receive captured audio data from a client device via the network interface; and
provide the captured audio data to a virtual audio driver of the virtual machine.

16. The device of claim 15, wherein the streaming interface is to:
stream audio data from the virtual machine to the client device over the network via the network interface.

17. The device of claim 15, wherein the streaming interface is to:
decode the captured audio data before providing the captured audio data to the virtual audio driver.

18. The device of claim 15, wherein the virtual audio driver is to:
store the captured audio data at an endpoint buffer of an operating system of the virtual machine.

19. The device of claim 18, wherein the operating system is to:
provide, by the virtual audio driver, the captured audio data to an operating system.

20. The device of claim 19, wherein the streaming interface is to:
communicate audio data to the network via the virtual audio driver.
